(19) United States
(12) Patent Application Publication
(10) Pub. No.: US 2014/0067929 A1
(43) Pub. Date: Mar. 6, 2014

(54) UPLOADING ONE OR MORE FILES FROM A SHARED FILE LINK

(71) Applicants: Ivan Kirigin, San Mateo, CA (US); Trevor Berg, San Francisco, CA (US); Jeffrey Michael Bartelma, San Francisco, CA (US)

(72) Inventors: Ivan Kirigin, San Mateo, CA (US); Trevor Berg, San Francisco, CA (US); Jeffrey Michael Bartelma, San Francisco, CA (US)

(21) Appl. No.: 13/596,735

(22) Filed: Aug. 28, 2012

(51) Int. Cl. G06F 15/16

(52) U.S. Cl. 709/204

(57) ABSTRACT

A system and method of sharing files between a user of a first client device and a user of a second client device, where the first and second client devices are operatively coupled to at least one file access server via a network. The method comprises the steps of generating a file-sharing link to a file set based on a request received from a first user. A file set viewing window is opened when a second user activates the file-sharing link. The at least one file sharing access server receives a request to upload one or more files by the second user via the file sharing link, and the at least one file access server receives the uploaded one or more files and stores the files to a location designated by the link.

### FIELD

Various embodiments described herein relate generally to sharing files over a network. Particular embodiments pertain to systems and methods for allowing a user to upload files to another user's folder over a network.

### BACKGROUND

Individuals often wish to share digital files with others. This is often done by simply e-mailing copies of the files to others, or by providing copies of the files on a physical medium such a flash drive. However, such techniques can be time-consuming and cumbersome—especially in cases where it is desirable to compile a centralized repository of files that are currently in the possession of a large number of different users. There is currently a need for systems and methods for addressing this issue and other issues.

### SUMMARY OF THE INVENTION

A computer-implemented method, according to various embodiments, provides a user of a file management system with the ability to upload files to a link sharer's account. In various embodiments, the method comprises the steps of: (1) receiving a request, from the link sharer, to receive a file sharing link for use in sharing one or more files from a particular file set; (2) at least partially in response to receiving the request, providing a file sharing link that may be used to access the one or more files; (3) receiving an indication that the file sharing link has been activated by the link recipient; (4) at least partially in response to receiving the indication that the file sharing link has been activated by the link recipient, displaying a representation of the one or more files along with a display element that may be activated to allow the link recipient to upload at least one file to the file set; (5) receiving an indication that the display element has been activated; and (6) at least partially in response to receiving the indication that the display element has been activated, facilitating uploading the at least one file to the file set.

In some embodiments, the one or more files are stored in a particular folder, and facilitating the upload of the at least one file to the file set comprises uploading the at least one file to the particular folder. In some of these embodiments, the file sharing link may be used to determine a path to the particular folder. In still other embodiments, the method further comprises determining whether predetermined permission criteria have been satisfied, and at least partially in response to determining that the permission criteria have been satisfied, automatically adding the at least one file to the file set. In yet other embodiments, the method further comprises determining whether predetermined permission criteria that have been specified by the link sharer have been satisfied, and at least partially in response to determining that the permission criteria have been satisfied, automatically adding the at least one file to the file set. In some of these embodiments, the predetermined permission criteria comprise one or more criteria selected from a group consisting of: (1) the link sharer and the link recipient are members of a common group on a social media web site; (2) the link recipient is within a list of contacts associated with the link sharer; and (3) the link sharer has previously manually granted the link recipient permission to directly upload files to the file set. In some embodiments, in response to receiving authorization from the link sharer to save the at least one file to the file set, saving the at least one file to the file set.

In another embodiment, a computer implemented method of sharing files between a link sharer and a link recipient comprises: (1) receiving a request, from the link sharer, to receive a file sharing link for use in uploading one or more files to a particular file set; (2) at least partially in response to receiving the request, providing a file sharing link that may be used to upload one or more files to the file set; (3) receiving an indication that the file sharing link has been activated by the link recipient; and (4) at least partially in response to receiving the indication that the file sharing link has been activated, facilitating uploading at least one file to the file set.

In some embodiments, the one or more files are stored in a particular folder, and facilitating the upload of the at least one file to the file set comprises uploading the at least one file to the particular folder. In various embodiments, the file sharing link may be used to determine a path to the particular folder. In still other embodiments, the method further comprises determining whether predetermined permission criteria have been satisfied, and at least partially in response to determining that the permission criteria have been satisfied, automatically adding the at least one file to the file set. In some embodiments, the predetermined permission criteria comprise one or more criteria selected from a group consisting of: (1) the link sharer and the link recipient are members of a common group on a social media web site; (2) the link recipient is within a list of contacts associated with the link sharer; and (3) the link sharer has previously manually granted the link recipient permission to directly upload files to the file set. In still other embodiments, the method further comprises determining whether predetermined permission criteria that have been specified by the link sharer have been satisfied, at least partially in response to determining that the permission criteria have not been satisfied, requesting authorization from the link sharer to save the at least one file to the file set, and in response to receiving authorization from the link sharer to save the at least one file to the file set, saving the at least one file to the file set.

In yet another embodiment a computer-implemented method of sharing files between a user of a first client device and a user of a second client device comprises: (1) receiving a request to generate a file set sharing link from the first client device; (2) generating a file set sharing link in response to the first client device request, wherein the file set sharing link is configured to allow the user of the second client device to upload one or more files to a first location specified by the link; (3) receiving a request from the link recipient to upload at least one file via the file set sharing link; and (4) receiving the at least one file, wherein the method further comprises at least one of: (i) automatically adding the uploaded at least one file to the first location specified by the link; and (ii) storing the uploaded at least one file to a second location specified by the link to allow the user of the first client device to manually approve the addition of the at least one file to the first location specified by the link.

### BRIEF DESCRIPTION OF THE DRAWINGS

Various embodiments of a computer system for displaying file and folder information to a user are described below. In the course of this description, reference will be made to the accompanying drawings, which are not necessarily drawn to scale, and wherein:

FIG. 1 is a block diagram of a file management system in accordance with an embodiment of the present system;

FIGS. 2A-2B are schematic representations of one embodiment of how files are segmented and stored in the file management system of FIG. 1;

FIG. 3 is a block diagram of a link based sharing module for use in the file management system of FIG. 1;

FIG. 4 depicts a flow chart that generally illustrates various steps executed by a file sharing system for uploading files from a shared link in accordance with one embodiment of the present system;

FIG. 5 illustrates a user interface menu for creating a file-sharing link for use in the file management system of FIG. 1;

FIG. 6 illustrates a screen display showing the link generated for a shared file set in accordance with one embodiment of the present system;

FIG. 7 illustrates one embodiment of a screen display that can be used to activate a shared file link in accordance with one embodiment of the present system;

FIG. 8 illustrates a screen displaying a representation of the shared file set associated with the file sharing link of FIG. 6 in accordance with one embodiment of the present system;

FIG. 9 illustrates an e-mail message that can be used to share the file sharing link of FIG. 6 in accordance with an embodiments of the present system;

FIG. 10 illustrates a second embodiment of a screen displaying a representation of a shared file set associated with the file sharing link of FIG. 6 in accordance with another embodiment of the present system;

FIG. 11 illustrates a screen display for uploading files by a link recipient into a link-sharing user's account in accordance with one embodiment of the present system; and

FIG. 12 illustrates a screen display that allows a user to manually select files to upload to the user's account in accordance with an embodiment of the present system.

### DETAILED DESCRIPTION

Various embodiments will now be described. It should be understood that the present system and method may be embodied in many different forms and should not be construed as limited to the embodiments set forth herein. Rather, these embodiments are provided so that this disclosure will be thorough and complete, and will fully convey the scope of the present system and method to those skilled in the art. Like numbers refer to like elements throughout.

### System Overview

In various embodiments, a file sharing and retrieval system is provided that allows a first user (the “link sharer”) to create a read-only link to one or more files, an empty folder, a group of folders or any other combination of files and folders. The link is referred to as “read-only” because it only allows a second user (hereinafter the “link recipient”) to view the files. The read-only link does not allow the link recipient to make changes to the content of the files or folders—such as editing files, deleting files or moving files between folders. In various embodiments, the link may allow users to download a local copy of the files to their computer. The link may, for example, be a URL or any other suitable indicia that includes a file path to the files and/or folders. Once the link is created, the link sharer can share the link with the link recipient (e.g., via e-mail) to allow the link recipient to view and download the files and folders associated with the link.

Once the link recipient clicks on the link (if it is an active link) or copies the link and pastes it into their browser's address bar, a window opens allowing the file recipient to view the contents of the files and/or folders or download a local copy of the files and/or folders to their computer. In addition to viewing and downloading the files, the window also provides the link recipient with the option to upload files to a location designated by the link (e.g. a folder or file set). For example, if the link sharer is the host of a seminar, the link sharer may want to share photos, notes, data files, etc. associated with the seminar, and may also want to collect such files from attendees of the seminar. In the alternative, the link sharer may not share any files but, instead, send the link to collect files from the seminar attendees. In either case, when the link is activated the window that opens includes a file upload link or button that allows the link recipient to upload files to the location designated by the link. In this way, the link sharer can obtain files without having to receive data disks or e-mail attachments.

When the link recipient activates the upload button, an upload window opens allowing the link recipient to search their local computer to select files to upload. The upload window may be configured to allow the link recipient to upload one file or more files to a location (e.g. a folder) within the link sharer's account, specified by the link sharer. Once the link recipient uploads the selected files to the specified location, the file storage server system may either automatically add the uploaded files to the location specified by the link sharer, or maintain the uploaded files separate from the link sharer's account until the link sharer manually accepts the uploaded files into his account.

The file storage server system may base automatic file acceptance on one or more file-sharing permissions set up by the link sharer. Permission criteria may, for example, be defined globally as preferences by the link sharer, or established on a link-by-link basis permitting the link sharer both flexibility and efficiency during generation of the link. File-sharing permissions may include, for example: (1) verifying that the link sharer and the link recipient belong to a common domain, social media collective or other user-defined group, (2) verifying that the link recipient's e-mail is included in the link sharer's contact information or address book, or (3) verifying that the link recipient is a registered user of the file storage and retrieval system. In other embodiments, sharing permissions may be based on any number of other conditions determinable by the system. In any case, if the specified file sharing criteria are met, the uploaded files are automatically added to the location designated by the link. In still other embodiments, the link sharer may require that the link sharer specifically authorizes the addition of any new files to the specified location within the link sharer's account.

### Exemplary System Platform

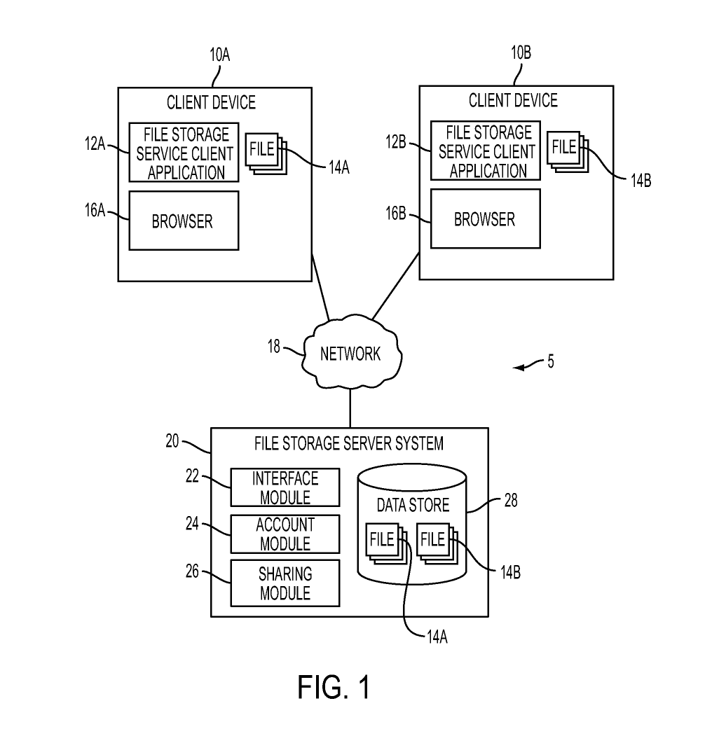

An exemplary platform for implementing various embodiments will now be discussed. Referring to FIG. 1, a system 5 implementing file set sharing and file uploading through link sharing is shown having a plurality of client devices 10A and 10B (collectively 10) and a file storage server system 20, which are all interconnected by at least one network 18. Various aspects of client devices and file storage server systems are discussed below.

Client Devices

In various embodiments, each client device 10 has a file storage service client application 12A and 12B (collectively 12) through which respective files 14A and 14B of that client are specified for storage in file storage server system 20. It is noted that in some embodiments synchronized copies of files 14A and 14B may be kept on both file storage server system 20 and each respective client device 10. In some embodiments, client devices 10 may provide a file-browser type interface (not shown) for directly manipulating the files stored on file storage server system 20 without maintaining a local copy, such as on a handheld device such as a smartphone or tablet computer. Client devices 10 may also include a web browser 16A and 16B (collectively 16) for retrieving and presenting web pages and other content from webservers. Examples of suitable web browsers that may be used by client devices 110 include FIREFOX, GOOGLE CHROME, INTERNET EXPLORER, OPERA, and SAFARI. It should be understood by those skilled in the art that web browser 16 may optionally be used to access file storage server system 20 instead of using file storage service client application 12.

Still referring to FIG. 1, while only two client devices 10A and 10B are shown for purposes of clarity, it should be understood by those skilled in the art that many client devices may be simultaneously connect through network 18 to file storage server system 20 at any given time. Examples of client devices 10 include, but are not limited to a desktop computer, a laptop computer, a tablet-computing device and a handheld computing device such as a personal digital assistant, a tablet computer or a smart phone (e.g., an IPHONE or BLACKBERRY, or a SYMBIAN or ANDROID-based smart phone). Each client device 10 may store one or more files on file storage server system 20, and the files may be stored in any file format. When file storage service client application 22 presents files to a user, the files may be arranged in folders and the folders themselves may be arranged in other folders, or in any other arbitrary arrangement supported by file storage server system 20, as determined by the user. However, one of skill in the art should understand in light of this disclosure that each user's file storage architecture may be considerably different from the next, and in some instances, the file storage architecture may be implemented to maximize storage and file retrieval efficiency.

File Storage Server System

File storage server system 20 stores files and manages access to those files using client devices 10. File storage server system 20 and its components may be implemented using any appropriate hardware and software for performing file serving and storage and retrieval functions. For purposes of clarity and ease of description, FIG. 1 illustrates exemplary file storage server 20.

File Storage Server System—Interface Module

In various embodiments, the file storage server system 20 includes an interface module 22, a data store 28, an account module 24, and a link based sharing module 26. Interface module 22 facilitates file access and file storage between file storage server system 20 and client devices 10. Interface module 22 receives files from and sends files to client devices 10 consistent with the user's preferences for sharing files. Interface module 22 may act as the counterpart to a client-side file-explorer style user interface that allows a user to manipulate files directly stored on file storage server system 20. In some embodiments, software operating on client devices 10 integrates network-stored files with the client's local file system to enable a user to manipulate network-stored files through the same user interface (UI) used to manipulate files on the local file system, e.g., via a file explorer, file finder or browser application. As an alternative or supplement to the client-side file-explorer interface, user interface module 22 may provide a web interface for client devices 10 to access (e.g. via browser 16) and allow a user to manipulate files stored on file storage server system 20. In this way, the user can directly manipulate files stored on file storage server system 20.

File Storage Server System—Data Store

In various embodiments, data store 28 stores files such as those uploaded using client devices 10. In the embodiment illustrated in FIG. 1, client 10A for a first user (e.g. link sharer) has stored files 14A and client 10B for a second user (e.g. a link recipient) has stored files 14B, which are stored in data store 28. Copies of stored files 14A and 14B may also be locally stored on respective client devices 10. Data store 28 maintains, for each user, information identifying the user, information describing the user's file directory, etc. in a file journal that is maintained for each user. In some embodiments, the file journal is maintained on file storage server system 20. This file journal may be updated periodically using information obtained directly from the file storage server system 20 and/or from information obtained from one or more client devices 10. In this way, the server-stored file journal on file storage server system 20 (hereinafter the “server-side file journal”) is updated when a file is changed at the server or on the local client. The file storage server system 20 then communicates with one or more clients devices 10 to assure that any relevant changes are reflected locally. For example, if a particular user makes a change to a particular file on a first client device, the change will be reflected in the server-side file journal, and the server-side file journal will be used to propagate the changes so that they are reflected both on the file storage server system 20 and on all client devices associated with the user. Such techniques may be implemented within the context of a synchronized file system such as the DROPBOX service of Dropbox, Inc. of San Francisco, Calif.

File Storage Server System—Account Module

Account module 24 tracks files stored in data store 28 and entries in the server-side file journal for each file. As users grant file access permissions to other users, account module 24 updates the server-side file journal associated with each user in data store 20. Account module 24 may also track client devices 10 that are associated with each user's account. For example, a user may want to share all their files between their desktop computer, tablet computer, and handheld device. To make such a sharing arrangement seamless to the user, the user's single account on file storage server system 20 is associated with each of the user's respective client devices by creating a new file reference string for each respective device and storing the file reference string in the user-associated server-side file journal. In this way, system 5 can determine which client device is requesting retrieval of the file. Additionally, in some embodiments where a copy of the file is stored on file storage server system 20 and locally on each client device, a separate client-side file journal is maintained on each client device to allow synchronization between and among the various client devices and file storage server system 20. In some embodiments, an application running on client device 10 manages synchronization of the client-side file journal with the server-side file journal in order to maintain synchronized local stored files with the server stored files.

File Storage Configuration

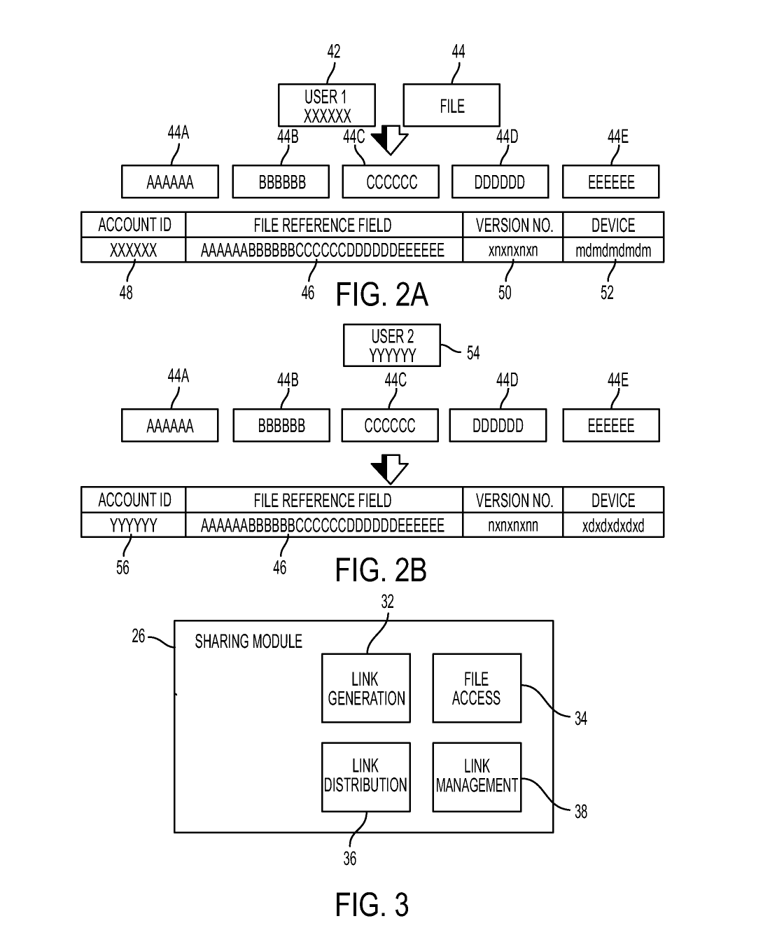

Referring to FIG. 2A, to expedite file handling and updating, in one embodiment, files stored in data store 28 are segmented. That is, when user 42 uploads the file to data store 28, file storage server system 20 is configured to segment the file into file segments 44A-44E and to assign a unique identifier to each file segment. In one embodiment, the file segments may be four (4) megabytes in size, but it should be understood by those skilled in the art in light of this discussion that the size of the file segments can be of any suitable size. In one embodiment, first file segment 44A is assigned a unique identifier AAAAAA, file segment 44B is assigned identifier BBBBBB, and so forth. In one embodiment, the unique identifier is a hash value calculated for each file segment using one or more hashing methods. In some embodiments, the file segments are stored in memory for later retrieval of the file by a user. That is, the file is stored as segments each having a unique identifier associated with the file that provides the identity and location of the file segment.

In various embodiments, file storage server system 20 is also configured to create a unique file reference string 46 for each file by concatenating file segment identifiers 44A-44E. User identifier XXXXXX and file reference string 46 are placed in a file journal entry 48. It should be understood that other information such as a version reference 50 and device reference 52 may also be included in file journal entry 48. In still other embodiments, information (metadata) related to the file and its contents (e.g., image orientation, pixel resolution and file type if the file is an image) may also be included in the file journal entry to properly orient and process the file for ease of viewing. Those skilled in the art will understand from this disclosure that any information associated with a file might be included in file journal entry 48 to enhance the features of the present system. In yet other embodiments, file journal entries 48 may be entered into a single server-side file journal that is used for all users, and in yet other embodiments, each user is assigned their own server-side file journal so that only file journal entries for each file associated with that user are stored in the server-side file journal assigned to that user.

Referring to FIG. 2B, when file 44 is shared with another user 54 having a unique user ID YYYYYY, in one embodiment, file storage system 20 is further configured to create another file journal entry 56 that associates file reference string 46 with the unique user identifier YYYYYY for user 54. Thus, when another user 54 is granted access to a file, it is unnecessary to store additional copies of the file in data store 28. Instead, when the other user click the file link, file journal entry 48 is used to reconstruct the file. That is, file storage server system 20 breaks the concatenated file journal entry 48 into its constituent parts and uses the unique segment identifiers to retrieve the various file segments that constitute the file. File storage server system 20 reconstructs the file from the various file segments and displays the file to the other user. It should be understood to those skilled in the art that other efficient methods of file storage and user association may be used within the context of the present system and are within the scope of the disclosed system.

File Storage Server System—Sharing Module

In various embodiments, the link sharer can select any, or a combination of, a single file, multiple files within a folder, an empty folder, multiple folders, or multiple files across multiple folders, each defined as a “file set” to be shared with one or more other users. It should be understood that when multiple files across multiple folders are shared as a file set, that file set defines a virtual folder for those files.

Referring to FIG. 3, a block diagram illustrating the components of a link based sharing module 26 in accordance with embodiments of the present system is shown. Link based sharing module 26 enables a user to provide others access to the user's file sets through a shared link. Link based sharing module 26 comprises a link generation module 32 for generating links to the shared file sets, a file access module 34 for accessing the files via the generated links, a link distribution module 36 for facilitating distribution of links to other users, a link management module 38 for viewing generated links, and a sharing database 40 that maintains information about linked file sets and related information such as corresponding sharing links.

Link generation module 32 is configured to generate a link corresponding to the file set specified by the user. In one embodiment, upon receiving a request to share a particular file set, link generation module 32 generates the unique file set descriptor of the shared file set and a unique file location path or URL that serves as the link. Sharing module 26 saves an association of the file set descriptor and the file location path or URL to sharing database 40. In some embodiments, the generated file sharing link is independent of the file set descriptor so that the file set descriptor cannot be inferred from the file sharing link, and vice versa. An independent file set descriptor and file location path or URL prevents malfeasance by making it essentially impossible to guess or reverse engineer a sharable link if it is not already known. As an example, when sharing a folder “Reunion” with a file ID of 3D8B99, link generation module 32 might generate a unique (e.g., one-way pad, or a pseudo-random value) URL such as https://www.service.com/s/28rtiz608u2mnco/BBQ.pdf, where the URL component 28rtiz608u2mnco cannot be reverse-engineered, and accordingly create an entry <3D8B99, https://www.service.com/s/28rtiz608u2mnco/BBQ.pdf> in sharing database 40. In one embodiment, the generated link can further be shortened. In some embodiments, the generated URL https://www.service.com/s/28rtiz608u2mnco/BBQ.pdf can further be shortened using a link-shortening service to a shorter URL (e.g., http://db.tt/xOFounw), and an additional association between the original link and the shortened link can be added to sharing database 40. In another embodiment, the file set can be directly associated with the shortened link rather than with an intermediate, longer generated link.

In other embodiments, a user can generate multiple different links to the same file set. Thus, the user can more selectively control access to the file set by distributing different selections from among the multiple different links to different link-recipient users or sets thereof. This may, for example, allow a user to revoke certain users' access to the file set while continuing to permit other users to access the file set (e.g., by deactivating certain users' links to the file set while maintaining other users' links in active status).

Moreover, since a file set link is versatile, in some embodiments, the system may include reference to a particular relevant application, or applications, in a link by embedding an application identifier in the generated link. As an example, the generated link for a given file set could be the URL https://www.service.com?app=1ps3q/s/28rtiz608u2mnco/BBQ.pdf, which specifies (via the portion “app=1ps3q”) that some application uniquely associated with the identifier “1ps3q” (e.g., Microsoft Word or Microsoft Visio) should be used to view the file set. Alternatively, the association between the link and the application or application plug-in can be made as an entry in sharing database 40, rather than by including an application identifier in the link. For example, in various embodiments, a user may generate a first link to a file set that specifies use of a first application for viewing the file set, and a second link that specifies use of a second application for viewing the file set. In this example, the sharing database 40 would in turn contain two corresponding entries: i.e., <file set identifier, first link identifier, first application identifier> and <file set identifier, second link identifier, second application identifier>. In another embodiment, link-based sharing module 26 may be configured to select the proper applications or application plug-ins to use in the file browser, e.g., based on the types of files in the file set. The link-based sharing module 26 may also allow users to specify which application should open a particular file or set of files when the files are accessed via a particular link.

### Exemplary System Operation

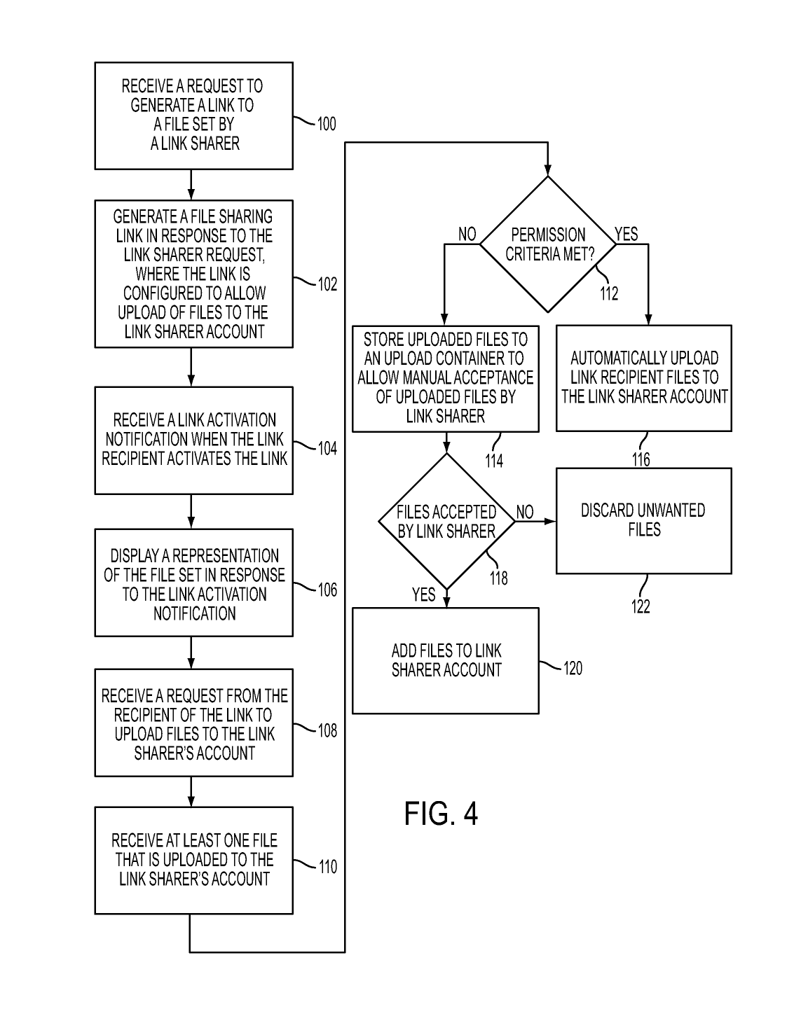

FIG. 4 depicts a method for allowing a content sharer to add files into a particular link sharer's content management account, which may contain, for example, various digital files and folders. The system may do this by generating a link that the content sharer uses to upload content directly into the link sharer's content management account. In various embodiments, the link facilitates the addition of files into a particular folder (or other upload location) specified by the link-sharer. In various embodiments, this may facilitate the consolidation of files from several different users into a single location.

Beginning at step 100, the file storage server system 20 (FIG. 1) receives a request, from a link sharer, to generate a link to a file set. Next, in step 102, the file storage server system generates a link in response to the request. The link is configured to cause the file storage server system to allow the link recipient to upload files to a location designated by the link (e.g., to a specified folder within the link sharer's account). The link sharer may then share the generated link with an individual (a “link recipient”) from whom the link sharer wishes to receive content. In step 104, after the link recipient receives and activates the link, the file storage server system 20 receives a link activation notification indicating that the link recipient has activated the link.

At step 106, the file storage server system displays a representation of the file set in response to the link activation. The representation of the file set may include a button that allows the file recipient to initiate a file upload to the location designated by the link. In step 108, when the file recipient selects (e.g., clicks on) the file upload button, the file storage server system receives a request to upload files to the account of the link sharer and causes a file upload screen to open. This screen allows the link recipient to choose one or more files to upload to the link sharer's account. After the link recipient selects one or more files to upload, the file storage server system facilitates uploading the selected file(s) to the link sharer's account. At step 110, the file storage server system receives the at least one file and saves the file to the link sharer's account (e.g., in a particular folder specified by the link).

At step 112, the file storage server system 20 checks at least one permission criteria to determine whether the link sharer will automatically accept uploaded files from the link recipient based on one or more file-sharing permission criteria that the link sharer sets. For example, in some embodiments, the generated link may contain an indicator that only allows a specific link recipient to activate the shared link. In certain embodiments, the generated link may contain information that requires the link recipient to be a registered user of file storage server system 20. In this way, file storage server system 20 may verify the identity of the link recipient based, for example, on their log in information, which allows the link sharer to eliminate unauthorized use of the link.

If the permission criteria are met, at step 116, the file storage server system automatically saves the link recipient's files to the linked file set. Otherwise, in step 114, the link recipient's uploaded files are stored in an upload location until the link sharer manually accepts each uploaded file (which the system may facilitate by displaying an appropriate message to the link sharer indicating that the files are awaiting approval). In step 118, if the link sharer accepts an uploaded file, the uploaded file is added, at step 120, to a location specified by the link such as the linked file set, another folder, or any other location that the link sharer designates. Otherwise, the uploaded files are discarded, at step 122. In particular embodiments, if the files are not accepted within a predetermined period, the system automatically discards the files.

It should be understood that the various steps described herein may vary in the context of different embodiments and that certain steps may be omitted and other steps may be added.

### Example User Experience

Link Sharing

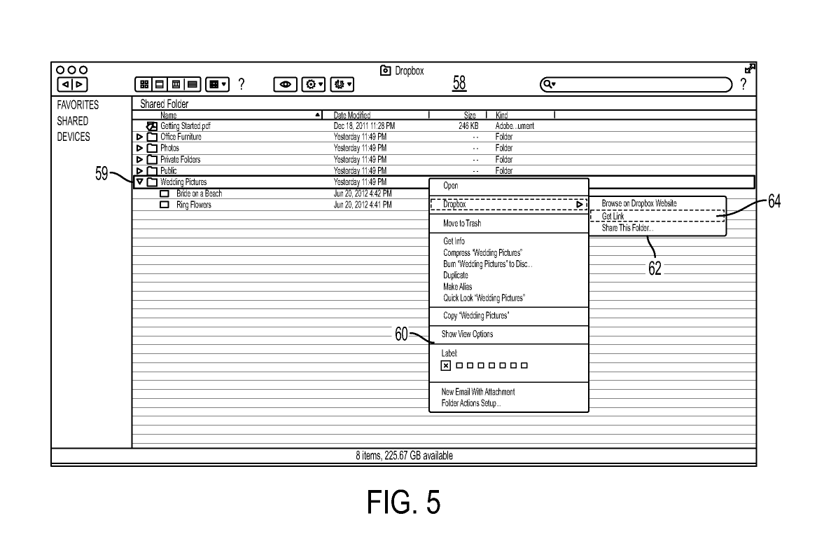

FIGS. 5-12 are computer screen shots that may be used to understand the experience of a link sharer and link recipient as they use a system according to an embodiment of the present system and method.

A link sharer may generate a link via link generation module 32 (FIG. 4) in different manners depending on the configuration of file server storage system (FIG. 2). In one embodiment, referring to FIG. 5, the user may generate a link using client application 16 provided on client device 10. That is, when a user right-clicks on a file set 59 to be shared, menu screen 60 opens allowing the user to select a DROPBOX option, thereby opening a second, context-sensitive menu 62. From second menu 62, the user selects a get link menu item 64.

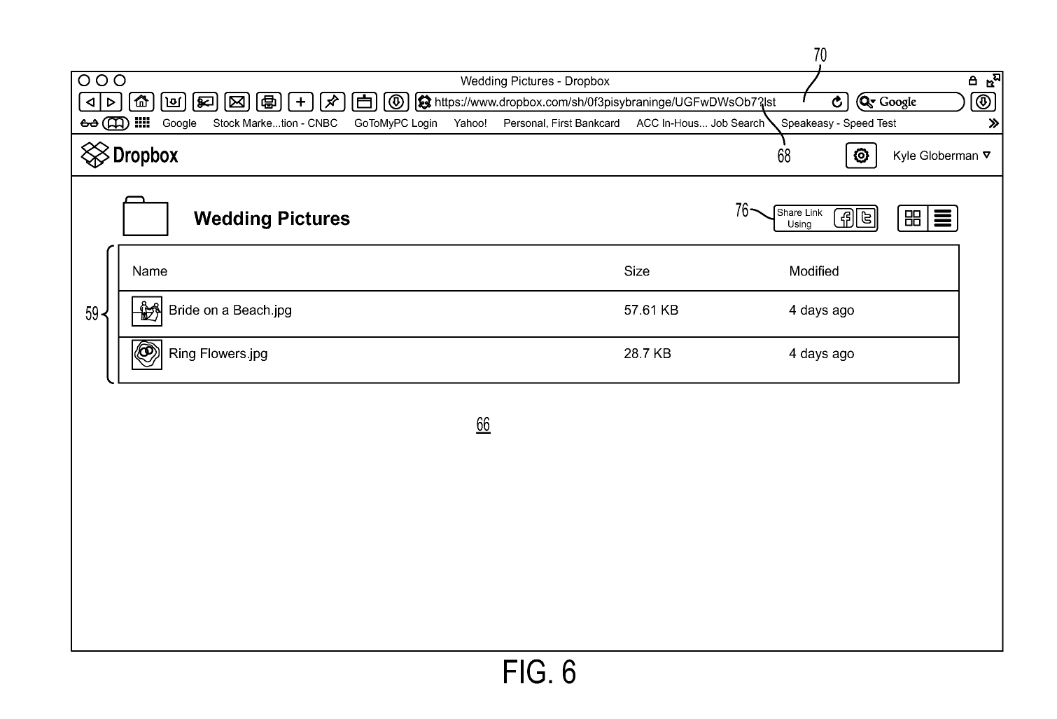

Referring to FIG. 6, once “get link” menu item 64 (FIG. 5) is selected, a browser window 66 opens displaying selected file set 59 in a file listing area (not numbered). Generated link 68, for shared file set 59, is displayed in browser address window 70. In some embodiments, a link sharing option area 76 is displayed that allows the user to share the link using a social media program such as, for example, FACEBOOK or TWITTER. Selection of either option prompts the link sharer for their login information for the selected service. Assuming that correct login information is provided, link distribution module 36 uses an application programming interface (“API”) of the selected service to disseminate the link via the service, such as by adding it as a post to the link sharer's page on a social networking service (e.g., Facebook), or by sending it as part of a textual message on a micro blogging service (e.g., Twitter). In yet other embodiments, other methods may be provided to share the link, such as through a server based e-mail client. In still other embodiments, the user may highlight link text 68, copy the link and paste it into an e-mail or other document. It should also be understood that generated link 68 could also be shared by copying the link and posting it on a webpage or through any other suitable means.

Link Activation

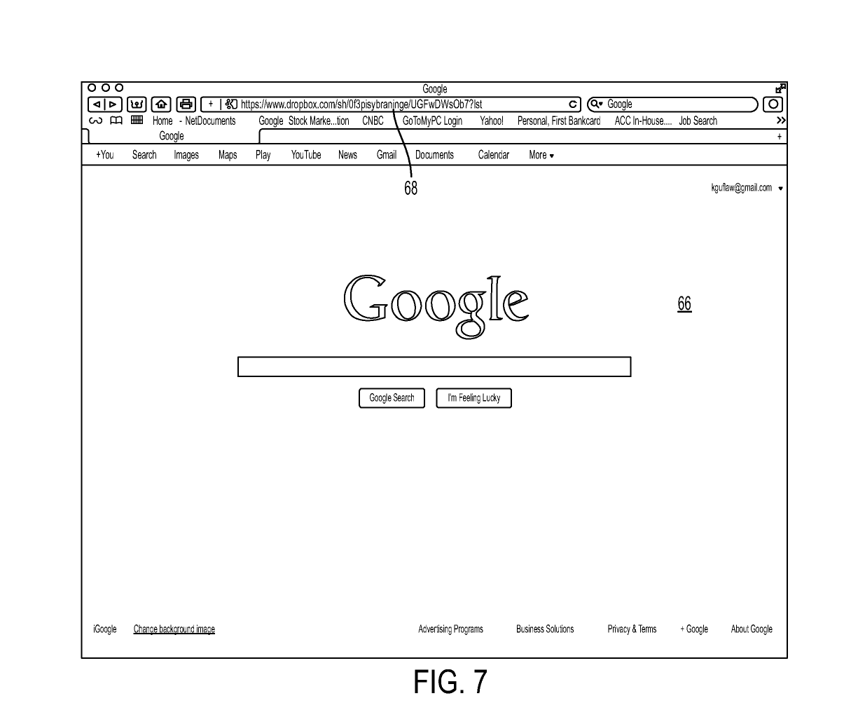

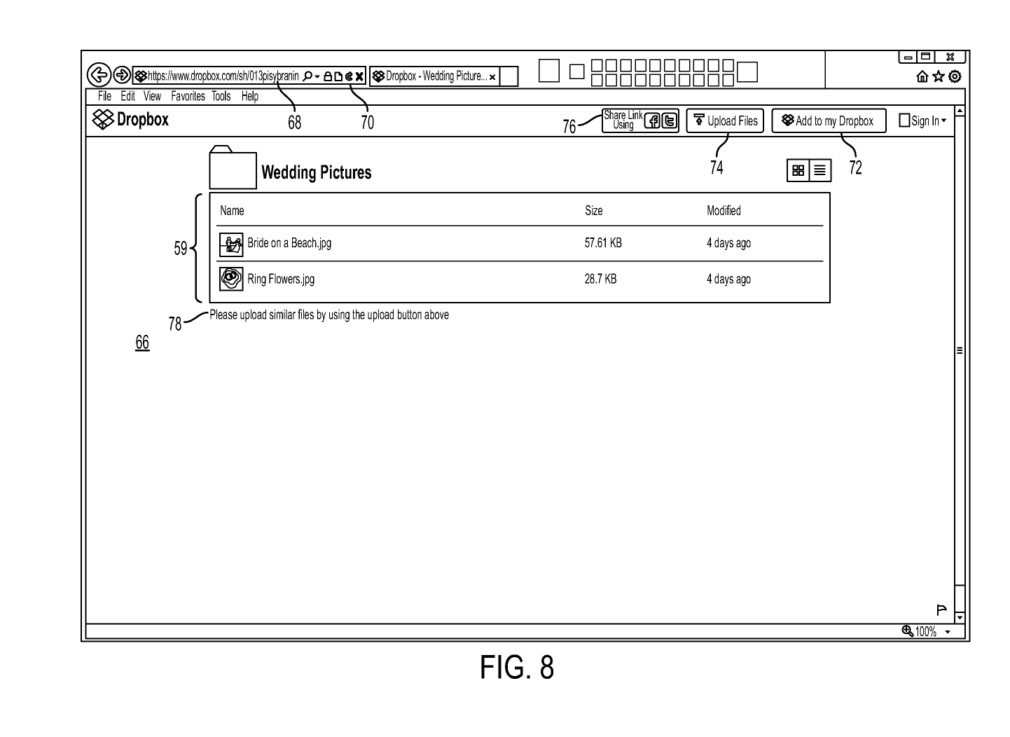

Once the link recipient receives the link, the link recipient may, for example, select (e.g., click on) the link if it is an active link or, referring to FIG. 7, the link recipient may copy the link and paste it into their browser's address bar. Upon entering link 68 in the browser's address bar, referring to FIG. 8, file access module 34 (FIG. 3) provides the shared file set and/or visual representations thereof to client 10 in response to the link recipient activating the generated link. That is, client 10 sends a corresponding request to link-based sharing module 26 (FIG. 3). The request is handled by file access module 34, which locates the entry in sharing database 40 using the parameters contained within the link, and extracts the associated file set identifier. File access module 34 then displays a representation of the file set that corresponds to the file set identifier by displaying file set 59 in browser window 66. In one embodiment, file access module 34 displays the representation of the file set using an application or application plug-in corresponding to a unique identifier embedded within, or otherwise associated with, the generated link, as described above.

Still referring to FIG. 8, browser window 66 may also include a message 78 instructing the link recipient to share similar files by uploading the file or files that would be of interest to the link sharer using upload files button 74 on browser window 66. Upload files button 74 allows the link recipient to upload files to an upload location, which can be, for example: (1) any one of the folders containing the file set; (2) another folder to maintain uploaded files until they are accepted; or (3) a virtual folder, or any other location designated by the link sharer to store uploaded files.

For example, the link sharer may share one or more links to photos from an event such as a wedding, and send the generated links to various link recipients that may have attended the wedding. When the link recipient views the shared file set (photos of the wedding) the system may display a message 76 that requesting that the link recipient upload any photos that the link recipient may have taken during the wedding. In this way, link recipients may collaborate with the link sharer to pool related files in a single location such as a wedding folder in the link sharer's DROPBOX account.

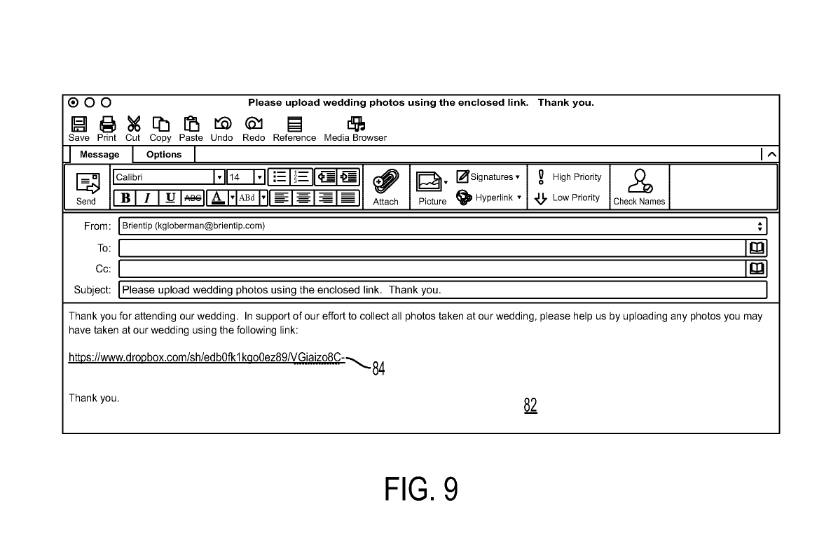

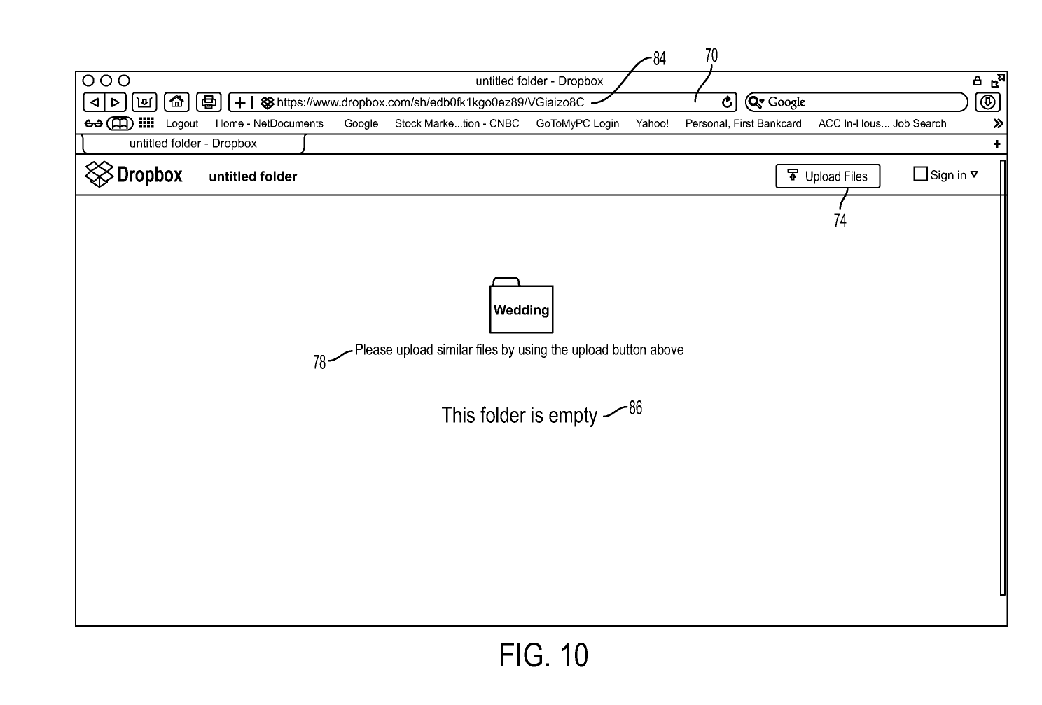

In other embodiments, the link sharer may use the system to generate a link that does not itself share any files, but that instead requests the link recipient(s) to upload certain types of files to a central repository (e.g., folder) within the link sharer's account. For example, the link sharer may have just been married, and by sending out a suitable link to other wedding attendees, the link-sharer can request that the other attendees use the link upload photos taken at the wedding to a folder within the link-sharer's account. For example, and referring to FIG. 9, a link sharer may send a link 84 in an e-mail 82 in the manner described above, and request that the link recipient use the link to upload related files to a designated location (e.g., folder) within their account. Thus, referring to FIG. 10, when the link recipient enters link 84 into browser address bar 70 and activates the link, a browser window displays a folder called wedding with a message 86 indicating to the link recipient that the folder is empty. Additionally, a message 78 requests that the link recipient upload similar files by using upload button 74. In this way, a link sharer does not necessarily need to share files to request a link recipient to upload files. This allows the link-sharer to obtain and consolidate relevant photos taken at the wedding by a variety of other attendees without having to call each attendee to request their photos.

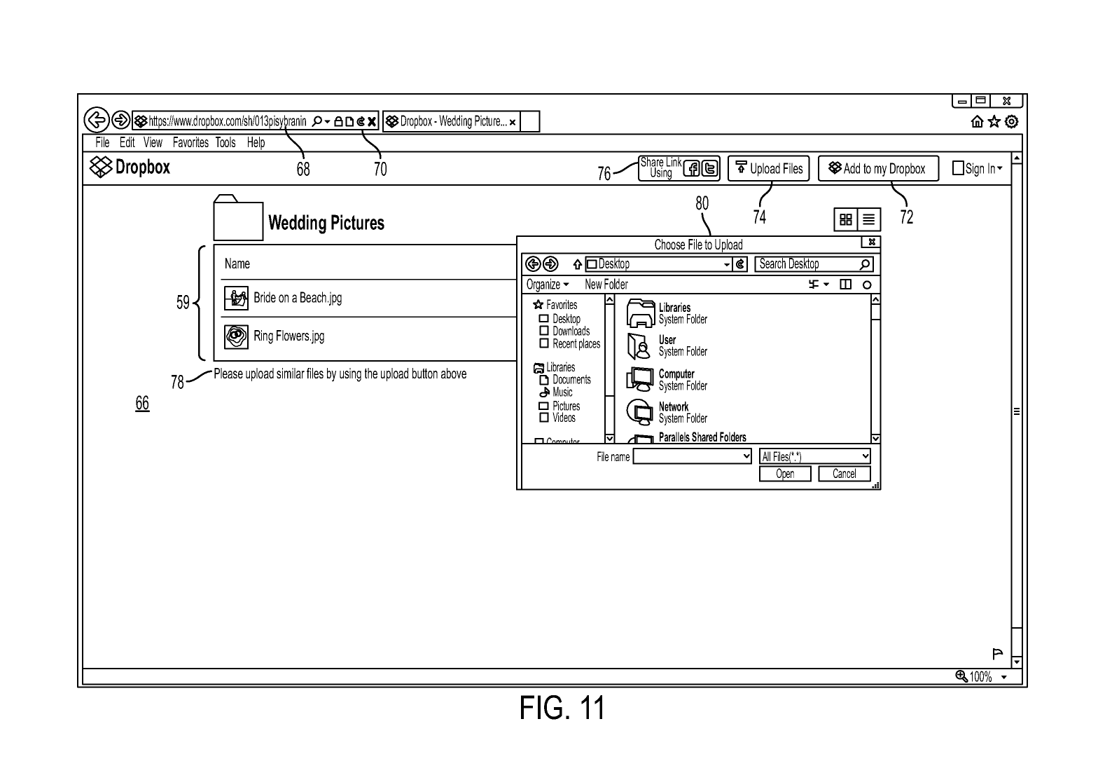

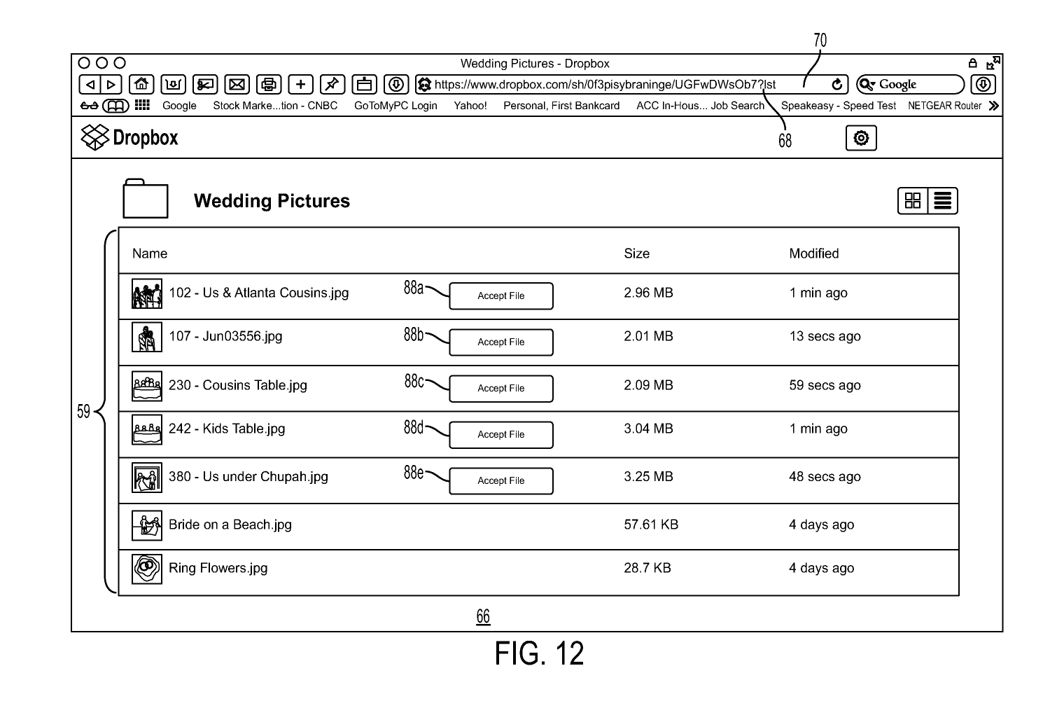

Referring to FIG. 11, when the link recipient selects upload button 74, file upload window 80 opens to allow the link recipient to choose a file (or files) to upload to the link sharer's upload location. Once a link recipient uploads one or more files, the files may either be automatically added to the link sharer's account, or the uploaded files may be maintained in the separate upload location allowing the link sharer the opportunity to manually accept each file. In an embodiment where a generated link is posted on the worldwide web for anyone to use, the link sharer may not want uploaded files to be automatically added to the designated location. This may be due to concerns, on the part of the link-sharer, about other individuals using the link to upload malicious or other unwanted files to the link-sharer's account. Accordingly, the link sharer may want to evaluate the relevancy and acceptability of each file and manually accept or reject each one. Referring to FIG. 12, when the link sharer reviews the shared file set 59, newly added files may each be displayed with an accept file button 88a-88e that allows the link sharer to accept each file after review. When the link sharer selects a particular accept file button, the corresponding uploaded file is moved from the upload location into the corresponding location that was designated by the link-sharer.

Permission Criteria for Automatic File Upload

In various embodiments, the link sharer might set up certain permission criteria that allow for automatic acceptance of files uploaded by the link recipient. For example, when the link sharer has a pre-established relationship with the link recipient, file acceptance may be automated based on one or more file-sharing criteria that the link sharer sets up. Such criteria may be defined globally as preferences by the link sharer, or established on a link-by-link basis permitting the link sharer both flexibility and efficiency during generation of the link. File-sharing permissions may include, for example: (1) verifying that the link sharer and the link recipient belong to a common domain, social media collective or other user-defined group, (2) verifying that the link recipient's e-mail is included in the link sharer's contact information or address book, or (3) verifying that the link recipient is a registered user of file storage and retrieval system. In other embodiments, sharing permissions may be based on any number of other conditions determinable by the system.

For example, in some embodiments, the generated link may contain an indicator that only allows a specific link recipient to activate the shared link. In certain embodiments, the generated link may contain information that requires the link recipient to be a registered user of file storage server system 20. In this way, file storage server system 20 may verify the identity of the link recipient based on their log in information, which allows the link sharer to eliminate unauthorized use of the link.

In still other embodiments, file storage server system 20 may be configured to verify link recipient information with the link sharer's contact information stored on client 10 or stored on file storage server system 20. Thus, when a link recipient attempts to upload files, file storage server system 20 confirms that the link recipient is a member of the link sharer's contacts by checking, for example, that the link recipient's e-mail address and/or domain is contained in the link sharer's contact information. If the requisite permission criteria for file uploading are met, file storage server system 20 will automatically add the uploaded files to the designated location. Otherwise, the files will be placed in an upload location until the link sharer approves the addition of the files, as described above.

It should be understood by those skilled in the art in light of this disclosure that permission criteria may also be based on: (1) cookies stored on the link recipient's client device 10, or metadata contained within the cookie; (2) information related to common membership in a social media group such as a FACEBOOK or YAHOO groups; or (3) by any other suitable criteria that allows the link recipient to be verified as a safe provider of files. For example, in the case of using cookie information to identify the link recipient, in one embodiment, file storage server system 20 can use session identification information contained in the cookie as a means of verifying the identity of the link recipient.

### CONCLUSION

Many modifications and other embodiments of the invention will come to mind to one skilled in the art to which this invention pertains having the benefit of the teachings presented in the foregoing descriptions and the associated drawings. For example, although the system may be adapted to allow a link sharer to send a link via a local e-mail client, in various embodiments, link distribution module 36 may be adapted to send generated links via an e-mail client resident on file storage server system 20.

It should also be understood that, although various embodiments are described above as using a link (e.g., a URL) to provide user access to shared file set, any other suitable indicia may be used for this purpose such as a link that includes a file path to the file set.

Various embodiments are described above as being adapted to: (1) automatically upload files to a designated location (e.g., any particular folder within the link sharer's account) if certain criteria are met; and (2) if the criteria are not met, to require manual approval of the files before they are uploaded to the designated location. However, it should be understood that, in certain system, the approval process may either be entirely automatic or entirely manual.

In light of the above, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

1. A computer implemented method of sharing files stored on a content management system between a link sharer and a link recipient, the method comprising:
receiving, by a content management system, a request, from the link sharer, to provide a file sharing link for use in sharing a file set;
at least partially in response to receiving the request, providing, by the content management system, a file sharing link to the link sharer, wherein the link sharer can distribute the file sharing link to a link recipient to access the file set;
after the link recipient receives the file sharing link, receiving, by the content management system, an indication that the file sharing link has been activated by the link recipient;
at least partially in response to receiving the indication that the file sharing link has been activated by the link recipient, facilitating, by the content management system, a display of a representation of the file set along with an interactive graphical element that may be activated to allow the link recipient to upload at least one file to the file set, wherein prior to uploading, the at least one file is absent from the file set;
receiving, by the content management system, an indication that the interactive graphical element has been activated by the link recipient; and
at least partially in response to receiving the indication that the interactive graphical element has been activated, facilitating, by the content management system, uploading the at least one file to the file set.

2. The method of claim 1, wherein:
facilitating the upload of the at least one file to the file set comprises uploading the at least one file to a location designated by the link.

3. (canceled)

4. The method of claim 1, further comprising:
at least partially in response to determining that predetermined permission criteria have been satisfied, automatically adding the at least one file to the file set.

5. The method of claim 1, further comprising:
at least partially in response to determining that predetermined permission criteria specified by the link sharer have been satisfied, automatically adding the at least one file to the file set.

6. The method of claim 5, wherein:
the predetermined permission criteria comprise one or more criteria selected from a group consisting of: (1) the link sharer and the link recipient are members of a common group on a social media web site; (2) the link recipient is within a list of contacts associated with the link sharer; and (3) the link sharer has previously manually granted the link recipient permission to directly upload files to the file set.

7. The method of claim 1, further comprising:
at least partially in response to determining that predetermined permission criteria specified by the link sharer have not been satisfied, requesting authorization from the link sharer to save the at least one file to the file set; and
in response to receiving authorization from the link sharer to save the at least one file to the file set, saving the at least one file to the file set.

8. The method of claim 1, wherein when accessed using the file sharing link, the file set is read-only.

9. (canceled)

10. The method of claim 1, wherein the content management system is a synchronized file sharing system.

11. A computer implemented method of sharing files stored on a content management system between a link sharer and a link recipient, the method comprising:
receiving, by a content management system, a request, from the link sharer, to provide a file sharing link for use by a link recipient in uploading one or more files to a file set;
at least partially in response to receiving the request, providing, by the content management system, a file sharing link to the link sharer, wherein the link sharer can distribute the file sharing link to a link recipient to upload one or more files to the file set;
after the link recipient receives the file sharing link, receiving, by the content management system, an indication that the file sharing link has been activated by the link recipient;
at least partially in response to receiving the indication that the file sharing link has been activated by the link recipient, providing, by the content management system, a displayed representation of the file set along with an interactive graphical element that may be activated to allow the link recipient to upload the one or more files to the file set, wherein prior to uploading, the one or more files are absent from the file set;
receiving, by the content management system, an indication that the interactive graphical element has been activated by the link recipient; and
at least partially in response to receiving the indication that the interactive graphical element has been activated, facilitating, by the content management system, uploading the one or more files to the file set.

12. The method of claim 11, wherein:
facilitating the upload of the one or more files to the file set comprises uploading the one or more files to a location designated by the link.

13. (canceled)

14. The method of claim 11, further comprising:
at least partially in response to determining that the predetermined permission criteria have been satisfied, automatically adding the one or more files to the file set.

15. The method of claim 11, further comprising:
at least partially in response to determining that the predetermined permission criteria specified by the link sharer have been satisfied, automatically adding the one or more files to the file set.

16. The method of claim 15, further comprising:
the predetermined permission criteria comprise one or more criteria selected from a group consisting of: (1) the link sharer and the link recipient are members of a common group on a social media web site; (2) the link recipient is within a list of contacts associated with the link sharer; and (3) the link sharer has previously manually granted the link recipient permission to directly upload files to the file set.

17. The method of claim 11, further comprising:
at least partially in response to determining that the predetermined permission criteria have not been satisfied, requesting authorization from the link sharer to save the one or more files to the file set; and
in response to receiving authorization from the link sharer to save the one or more files to the file set, saving the one or more files to the file set.

18. (canceled)

19. The method of claim 11, wherein the content management system is a synchronized file sharing system.

20. A computer-implemented method of sharing files stored on a content management system between a user of a first client device and a user of a second client device, the method comprising the steps of:
receiving, by a content management system, a request to generate a file set sharing link from the first client device, the file set sharing link specific to a file set;
generating, by the content management system, the file set sharing link in response to the first client device request, wherein the file set sharing link is configured to allow the user of the second client device to upload one or more files to a first location designated by the link;
at least partially in response to receiving an indication that the file set sharing link has been activated by the user of the second client device, facilitating, by the content management system, a display of a representation of the file set along with an interactive graphical element that may be activated to allow the user of the second client device to upload at least one file to the file set, wherein prior to uploading, the at least one file is absent from the file set;
receiving, by the content management system, an indication that the interactive graphical element has been activated by the user of the second client device; and
at least partically in response to receiving the indication that the interactive graphical element has been activated, facilitating, by the content management system, uploading the at least one file, wherein the method further comprises at least one of:
automatically adding, by the content management system, the uploaded at least one file to the first location designated by the link; or
storing, by the content management system, the uploaded at least one file to a second location to allow the user of the first client device to manually approve the addition of the at least one file to the first location designated by the link.

21. The computer implemented method of claim 2, wherein the location designated by the link is a folder in an account of the link sharer.
